(19) United States
(12) Patent Application Publication
(10) Pub. No.: US 2014/0172372 A1
(43) Pub. Date: Jun. 19, 2014

(54) OPERATION SPEED AS A DYNAMIC LEVEL LINE

(71) Applicant: MICROSOFT CORPORATION, Redmond, WA (US)

(72) Inventors: Francisco Alvarez Cavazos, Bothell, WA (US); Jonathan M. Class, Snohomish, WA (US); Jerry Joyce, North Bend, WA (US); Jordi Mola, Redmond, WA (US); Guillermo Ortiz Pena, Kirkland, WA (US); Ben Truelove, Lynnwood, WA (US)

(73) Assignee: Microsoft Corporation, Redmond, WA (US)

(21) Appl. No.: 13/716,212

(22) Filed: Dec. 17, 2012

(51) Int. Cl. G06F 11/34

(52) U.S. Cl. CPC G06F 11/3409
USPC 702/186

(57) ABSTRACT

In one embodiment, a performance metric tracker may show an operation performance metric in context with an operation performance history to a user. The performance metric tracker may track a current operation performance metric of the data resource operation. The performance metric tracker may maintain an operation performance history for a data resource operation. The performance metric tracker may present the current operation performance metric in relation to the operation performance history to a user.

### BACKGROUND

An operating system may track the progress of an operation that transfers or modifies a data resource. The operating system may present the progress to a user so that the user may be aware of operation efficiency. For example, the operating system may expand a loading bar within a fill frame to demonstrate the progress of the operation. Once the operation has been completed, the loading bar may completely fill the fill frame.

### SUMMARY

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

Embodiments discussed below relate to a performance metric tracker that shows an operation performance metric in context with an operation performance history to a user. The performance metric tracker may track a current operation performance metric of a data resource operation. The performance metric tracker may maintain an operation performance history for the data resource operation. The performance metric tracker may present in realtime the current operation performance metric in relation to the operation performance history to a user.

### DRAWINGS

In order to describe the manner in which the above-recited and other advantages and features can be obtained, a more particular description is set forth and will be rendered by reference to specific embodiments thereof which are illustrated in the appended drawings. Understanding that these drawings depict only typical embodiments and are not therefore to be considered to be limiting of its scope, implementations will be described and explained with additional specificity and detail through the use of the accompanying drawings.

FIG. 1 illustrates, in a block diagram, one embodiment of a computing device.

FIG. 2 illustrates, in a block diagram, various embodiments of data manipulation.

FIG. 3 illustrates, in a block diagram, one embodiment of a simple completion percentage tracking graphical user interface.

FIG. 4 illustrates, in a block diagram, one embodiment of an operation performance metric tracking graphical user interface.

FIG. 5 illustrates, in a block diagram, one embodiment of an aggregate operation speed history.

FIG. 6 illustrates, in a flowchart, one embodiment of a method for tracking an operation performance metric for a data resource operation.

FIG. 7 illustrates, in a flowchart, one embodiment of a method for displaying a current operation performance metric and operation performance history comparison.

FIG. 8 illustrates, in a flowchart, one embodiment of a method for tracking an operation speed for a data resource operation.

FIG. 9 illustrates, in a flowchart, one embodiment of a method for tracking an aggregate operation speed for concurrent data resource operations.

### DETAILED DESCRIPTION

Embodiments are discussed in detail below. While specific implementations are discussed, it should be understood that this is done for illustration purposes only. A person skilled in the relevant art will recognize that other components and configurations may be used without parting from the spirit and scope of the subject matter of this disclosure. The implementations may be a machine-implemented method, a tangible machine-readable medium having a set of instructions detailing a method stored thereon for at least one processor, or a performance metric tracker for a data resource operation.

A file manager of an operating system may allow a user to execute a copy operation, execute a move operation, change data properties, execute a delete operation or make other alterations to a file or a folder of files. A performance metric tracker of the operating system may track an operation performance metric of the data resource operation. An operation performance metric is a value that describes the manner that the operating system is performing the data resource operation, such as operation speed, as opposed to whether the operating system has completed the data resource operation. The operation speed may be in megabytes per second, in the case of a copy operation, or in items per second, in the case of a deletion operation. If a data resource operation is active, the performance metric tracker may show a dynamic level line and an accompanying metric caption. If the data resource operation is not active, or not progressing towards completion, the performance metric tracker may hide, or not render, the dynamic level line and the metric caption.

As the caption refresh rate for the metric caption may be different from a line refresh rate for the dynamic level line, the performance metric tracker may calculate a display speed to present to the user. A display speed is the operation speed represented by the dynamic level line as processed by a smoothing function. The smoothing function may remove any sudden changes to the operation speed by minimizing any acceleration or deceleration, facilitating the user tracking the operation speed. The smoothing function may be an acceleration-deceleration-velocity physics filter. If the current speed is greater than the display speed, the dynamic level line may rise in larger increments each time the interface updates. If the current speed changes in such a way that the dynamic level line changes direction, the velocity of the dynamic level line movement is lost and accelerates in the new direction. After calculating the display speed, the metric performance tracker may scale the dynamic level line to the visual representation height to obtain the level. This height may be used to update the dynamic level line and the speed caption position, and to cause the chart to rescale.

Thus, in one embodiment, a performance metric tracker may show an operation performance metric in context with an operation performance history to a user. The performance metric tracker may track a current operation performance metric of a data resource operation. The performance metric tracker may maintain an operation performance history for the data resource operation. The performance metric tracker may present in realtime the current operation performance metric in relation to the operation performance history to a user.

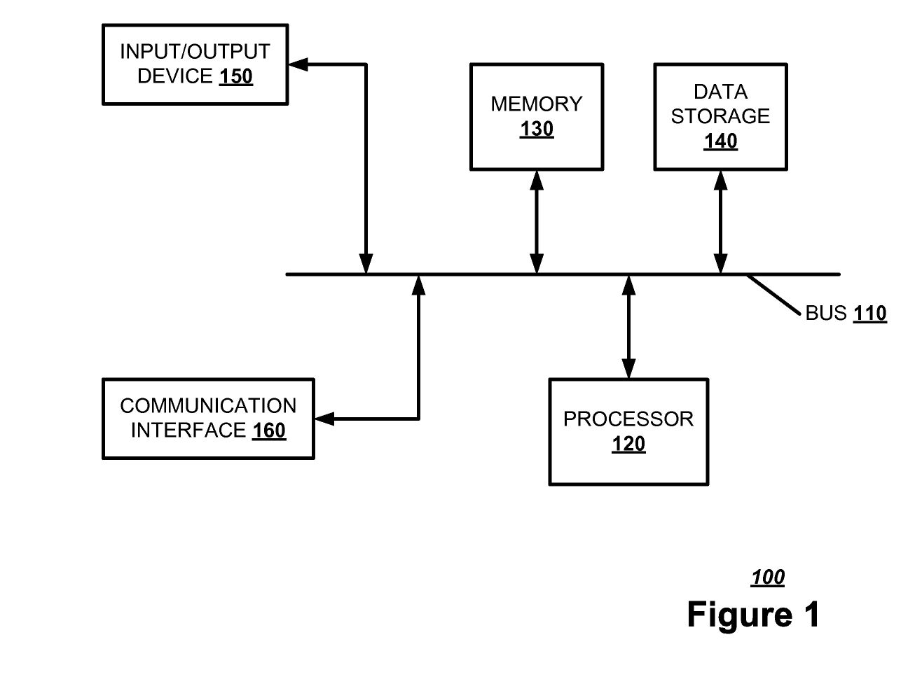

FIG. 1 illustrates a block diagram of an exemplary computing device 100 which may act as performance metric tracker. The computing device 100 may combine one or more of hardware, software, firmware, and system-on-a-chip technology to implement performance metric tracker. The computing device 100 may include a bus 110, a processor 120, a memory 130, a data storage 140, an input/output device 150, and a communication interface 160. The bus 110, or other component interconnection, may permit communication among the components of the computing device 100.

The processor 120 may include at least one conventional processor or microprocessor that interprets and executes a set of instructions. The memory 130 may be a random access memory (RAM) or another type of dynamic data storage that stores information and instructions for execution by the processor 120. The memory 130 may also store temporary variables or other intermediate information used during execution of instructions by the processor 120, such as an operation performance history for a data resource operation based on an intra-operation performance. The data storage 140 may include a conventional ROM device or another type of static data storage that stores static information and instructions for the processor 120. The data storage 140 may include any type of tangible machine-readable medium, such as, for example, magnetic or optical recording media, such as a digital video disk, and its corresponding drive. A tangible machine-readable medium is a physical medium storing machine-readable code or instructions, as opposed to a signal. Having instructions stored on computer-readable media as described herein is distinguishable from having instructions propagated or transmitted, as the propagation transfers the instructions, versus stores the instructions such as can occur with a computer-readable medium having instructions stored thereon. Therefore, unless otherwise noted, references to computer-readable media/medium having instructions stored thereon, in this or an analogous form, references tangible media on which data may be stored or retained. The data storage 140 may store a set of instructions detailing a method that when executed by one or more processors cause the one or more processors to perform the method. The data storage 140 may also be a database or a database interface for storing a previous operation speed average.

The input/output device 150 may include one or more conventional mechanisms that permit a user to input information to the computing device 100, such as a keyboard, a mouse, a voice recognition device, a microphone, a headset, a gesture recognition device, a touch screen, etc. The input/output device 150 may include one or more conventional mechanisms that output information to the user, including a display, a printer, one or more speakers, a headset, or a medium, such as a memory, or a magnetic or optical disk and a corresponding disk drive. The communication interface 160 may include any transceiver-like mechanism that enables computing device 100 to communicate with other devices or networks. The communication interface 160 may include a network interface or a transceiver interface. The communication interface 160 may be a wireless, wired, or optical interface.

The computing device 100 may perform such functions in response to processor 120 executing sequences of instructions contained in a computer-readable medium, such as, for example, the memory 130, a magnetic disk, or an optical disk. Such instructions may be read into the memory 130 from another computer-readable medium, such as the data storage 140, or from a separate device via the communication interface 160.

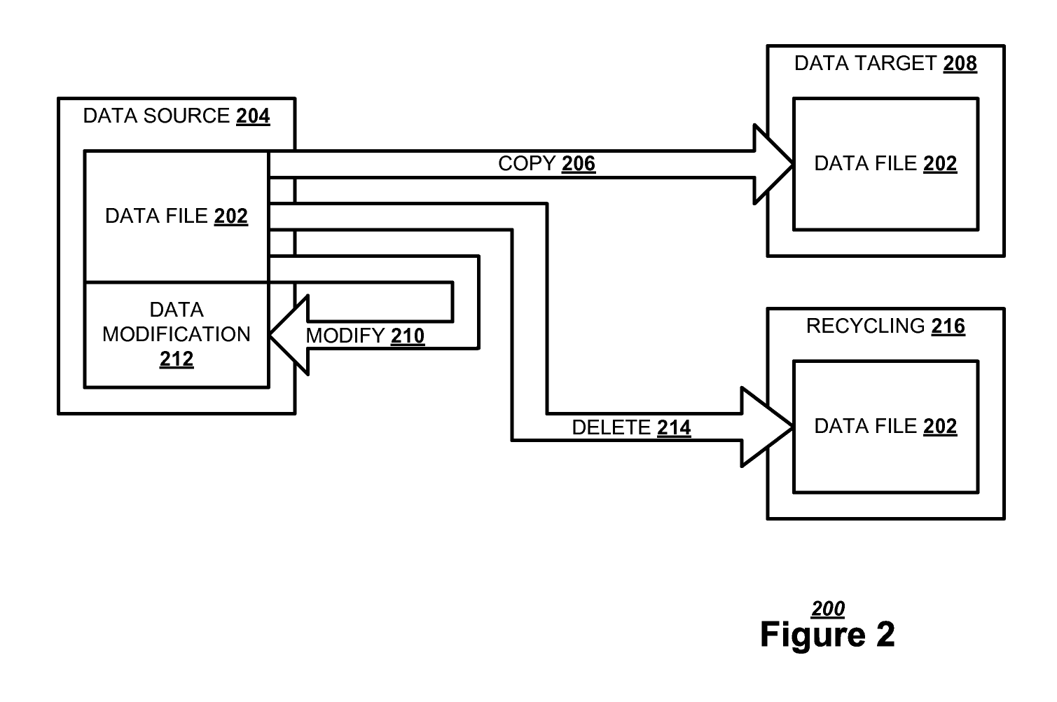

FIG. 2 illustrates, in a block diagram, various embodiments of data manipulation 200. An operating system may perform a number of data resource operations on a data file 202. A data resource operation is any alterations to a data file. A data resource operation may bundle multiple data alterations to one or more data files as a single data resource operation. A file manager of an operating system may store a data file 202 at a data source 204. A copy engine of the file manager may execute a copy operation 206 to copy the data file 202 from the data source 204 to the data target 208. A modification engine of the file manager may execute a modify operation 210 to apply a data modification 212 of the data file 202 in the data source 204. A deletion engine of the file manager may execute a delete operation 214 by moving the data file 202 to a recycling queue 216.

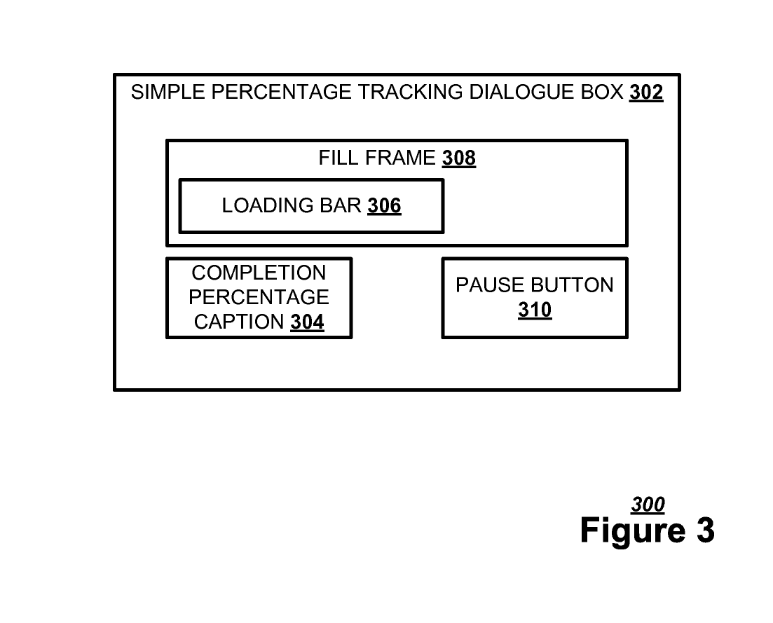

The operating system may track the performance of each of these data resource operations and display a metric of the performance to the user. FIG. 3 illustrates, in a block diagram, one embodiment of a simple completion percentage tracking graphical user interface 300. A simple percentage tracking dialogue box 302 may have a completion percentage caption 304 that describes in numerical form the percentage of the data resource operation that has occurred. For example, if 2.52 MB of a 5.6 MB data file 202 has been copied to a data target 208, the completion percentage caption 304 may show that 45% of the file has been copied. The simple percentage tracking dialogue box 302 may visually represent this data resource operation by expanding a loading bar 306 to fill in a fill frame 308. Using the previous example, the loading bar 306 may fill 45% of the fill frame 308. Once the data resource operation has been completed, the loading bar 306 may completely fill the fill frame 308. The simple percentage tracking dialogue box 302 may have a virtual pause button 310 that, when selected, may pause the data resource operation. Pausing the data resource operation ceases a data process while still maintaining the state of that data process so that the process may be restarted without having to repeat any actions.

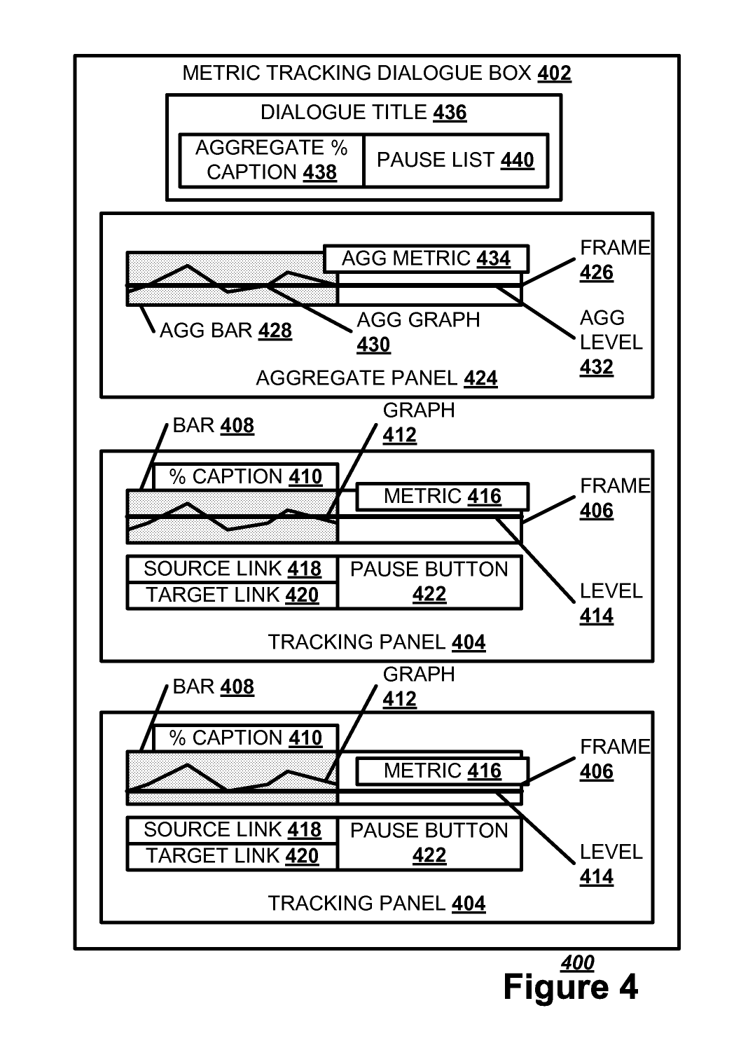

The operating system may provide a more data-rich user experience by presenting the current operation performance metric in relation to the operation performance history. FIG. 4 illustrates, in a block diagram, one embodiment of an operation performance metric tracking graphical user interface 400. An operation performance metric tracking dialogue box 402 may present an operation tracking panel 404 that displays an operation performance metric for a data resource operation. The operation tracking panel 404 may display a fill frame 406 that is proportionately filled by a loading bar 408 as the data resource operation is completed. The operation tracking panel 404 may display a completion percentage caption 410 by the fill frame 406 to indicate the percentage of the data resource operation that has been completed.

The operating system may track a granular operation performance history of a data resource operation. The granular operation performance history is a record of previous operation performance metrics linking an operation performance metric to a percentage completion point. The operation tracking panel 404 may display the granular operation performance history as a line graph 412 to display to a user changes in the operation performance history. The operation tracking panel 404 may present the current operation performance metric as a dynamic level line 414. The dynamic level line 414 may move as the current operation performance metric changes, not necessarily synchronized with the operation performance history. The operation tracking panel 404 may present in realtime the dynamic level line 414 representing the current operation performance metric in relation to a line graph 412 representing the operation performance history to a user. The operating system may use a smoothing function to minimize any sudden shifts in the dynamic level line 414. The operation tracking panel 404 may further display the current operation performance metric as a metric caption 416. The metric caption 416 may have a metric caption position within the operation tracking panel 404 aligned with the dynamic level line 414, so that the metric caption 416 moves as the dynamic level line 414 moves. The operating system may anticipate a level change in the current operation performance metric based on previous performance or current system conditions, and move the dynamic level line 414 accordingly. The dynamic level line 414 may be updated at a line refresh rate. The metric caption 416 may be updated at a caption refresh rate. The line refresh rate may be differentiated from the caption refresh rate.

The operation tracking panel 404 may have a set of user controls managing the data resource operation. A source link 418 may connect the user to the data source 204 where the data file 202 is located. A target link 420 may connect the user to the data target 208 where the data file 202 is copied. A virtual pause button 422 may pause the data resource operation when selected by the user.

The operation performance metric tracking dialogue box 402 may aggregate the performances of multiple data resource operations. The operation performance metric tracking dialogue box 402 may present an aggregate operation tracking panel 424 that displays an aggregate operation performance metric for each data resource operation. The aggregate operation tracking panel 424 may display an aggregate fill frame 426 that is proportionately filled by an aggregate loading bar 428 as each data resource operation is completed. The aggregate operation tracking panel 424 may display the aggregate operation performance history as an aggregate line graph 430 to display to a user changes in the aggregate operation performance history. The aggregate operation tracking panel 424 may present the aggregate current operation performance metric as an aggregate dynamic level line 432. The aggregate operation tracking panel 424 may further display the aggregate current operation performance metric as an aggregate metric caption 434.

The operation performance metric tracking dialogue box 402 may have a dialogue title 436 that describes an aggregate completion percentage in an aggregate completion percentage caption 438. The dialogue title 436 may identify any paused operations in a pause list 440.

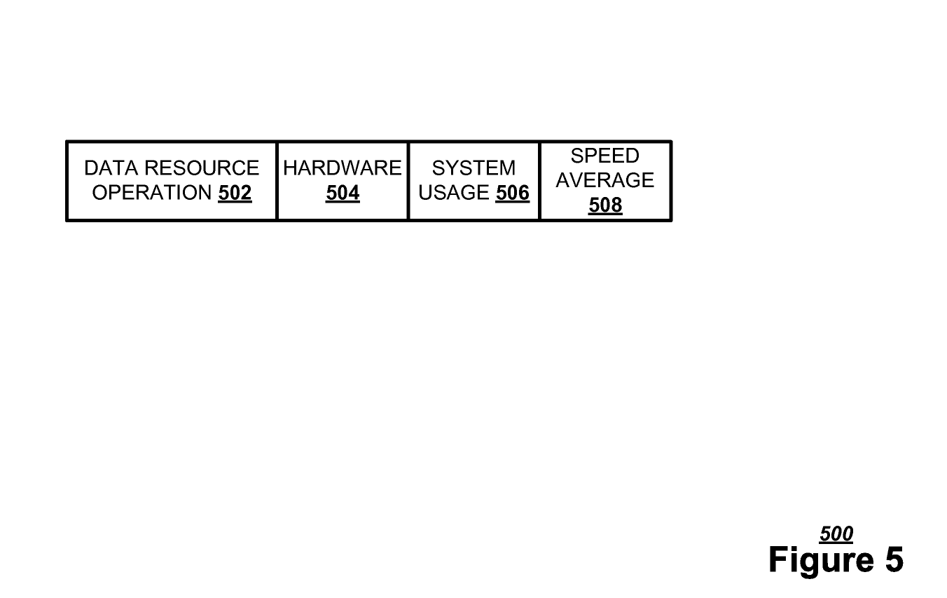

The operation system may base the operation performance history on an intra-operation performance or on a previous operation metric average. FIG. 5 illustrates, in a block diagram, one embodiment of an aggregate operation speed history record 500 for creating an operation performance history. The aggregate operation speed history record 500 may identify the data resource operation with a data resource operation identifier 502. The aggregate operation speed history record 500 may describe the hardware available for use in a hardware field 504. The aggregate operation speed history record 500 may specify in a system usage field 506 the percentage and type of system resources being used by other processes during the data resource operation. The aggregate operation speed history record 500 may describe a granular operation metric average array 508.

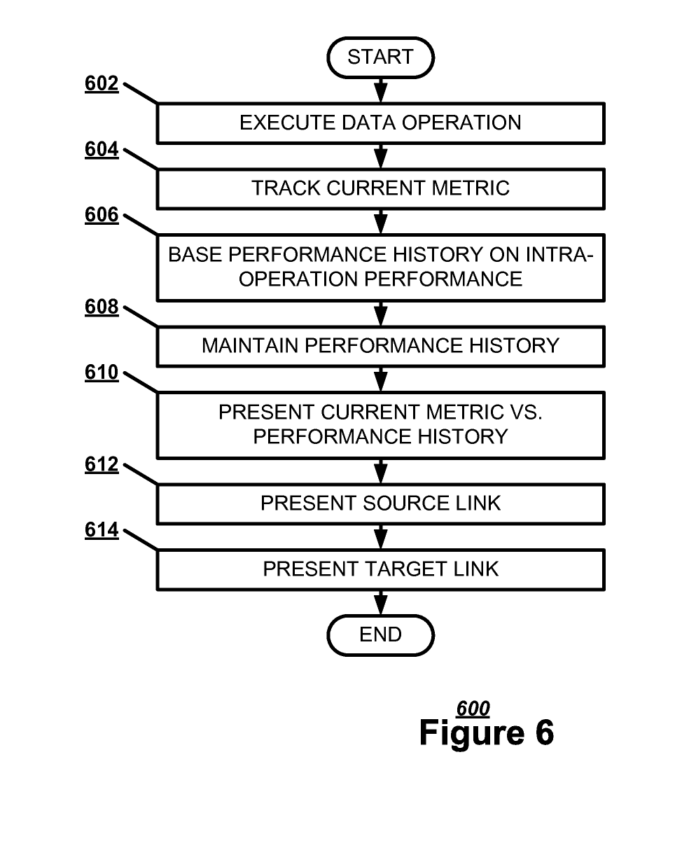

FIG. 6 illustrates, in a flowchart, one embodiment of a method 600 for tracking an operation performance metric for a data resource operation. The performance metric tracker may execute a data resource operation (Block 602). The performance metric tracker may track a current operation performance metric of the data resource operation (Block 604). The performance metric tracker may base the operation performance history on an intra-operation performance (Block 606). Alternately, the performance metric tracker may base the operation performance history on a previous operation metric average. The performance metric tracker may maintain an operation performance history for a data resource operation (Block 608). The performance metric tracker may present in realtime the current operation performance metric in relation to the operation performance history to a user (Block 610). The performance metric tracker may present a source link 418 to connect a user to a data source 204 for a copy operation 206 (Block 612). The performance metric tracker may present a target link 420 to connect a user to a data target 208 for a copy operation 206 (Block 614).

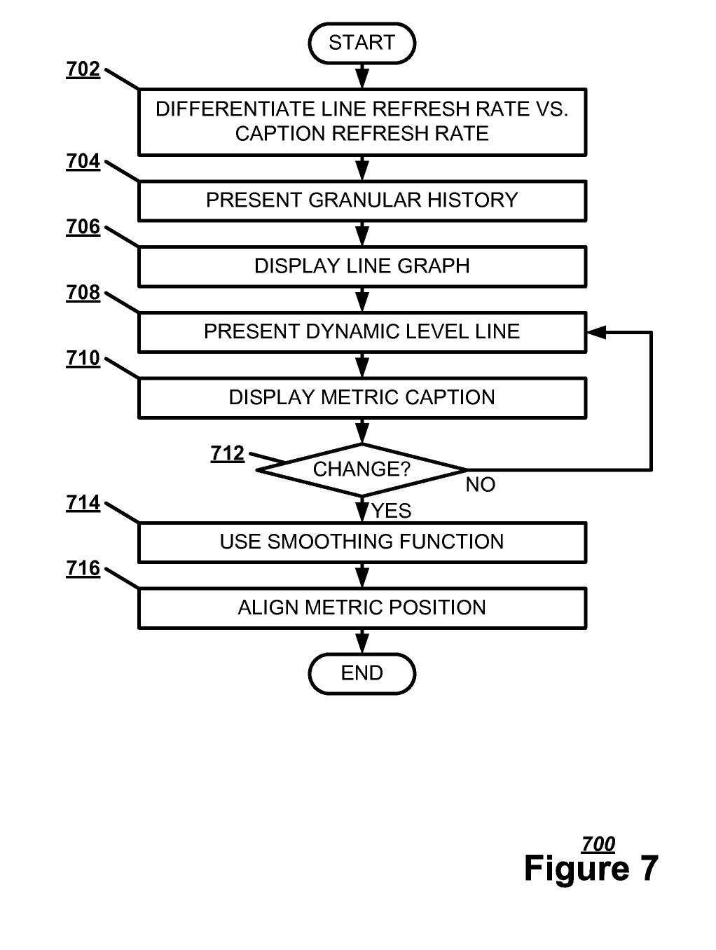

FIG. 7 illustrates, in a flowchart, one embodiment of a method 700 for displaying a current operation performance metric and operation performance history comparison. The performance metric tracker may differentiate a line refresh rate for a dynamic level line 414 from a caption refresh rate for a metric caption 416 (Block 702). The performance metric tracker may present a granular operation performance history for the data resource operation (Block 704). The performance metric tracker may display the granular operation performance history as a line graph 412 (Block 706). The performance metric tracker may present the current operation performance metric as a dynamic level line 414 (Block 708). The performance metric tracker may describe the current operation performance metric by displaying a metric caption 416 (Block 710). If the performance metric tracker anticipates a level change in the current operation performance metric (Block 712), the performance metric tracker may move the dynamic level line 414 using a smoothing function (Block 714). The performance metric tracker may align a metric caption position of the metric caption with the dynamic level line 414 representing the current operation performance metric (Block 716).

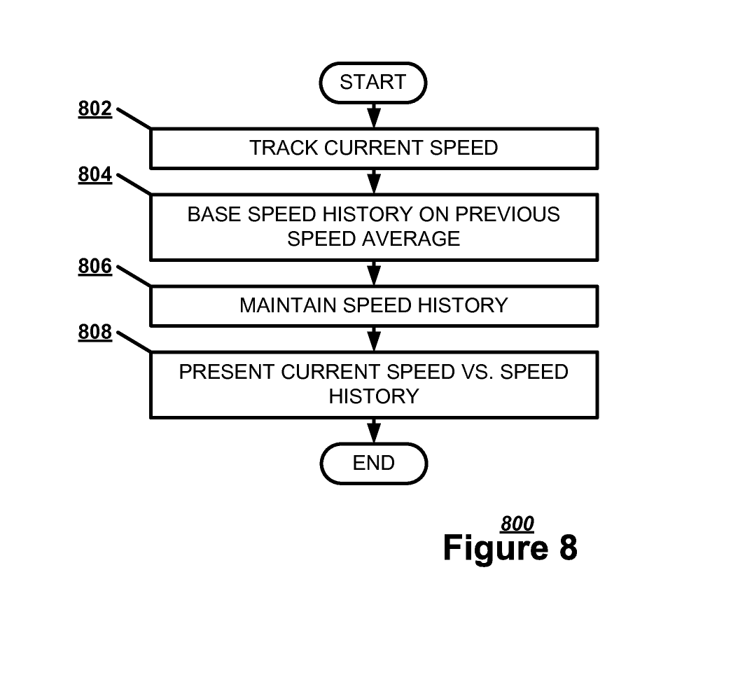

The operation performance metric may be operation speed. FIG. 8 illustrates, in a flowchart, one embodiment of a method 800 for tracking an operation speed for a data resource operation. The performance metric tracker may track a current operation speed of a data resource operation (Block 802). The performance metric tracker may base the operation speed history on a previous operation speed average (Block 804). Alternately, the performance metric tracker may base the operation speed history on an intra-operation performance. The performance metric tracker may maintain an operation speed history for the data resource operation (Block 806). The performance metric tracker may present in realtime the current operation speed as a dynamic level line 414 in relation to the operation speed history to a user (Block 808).

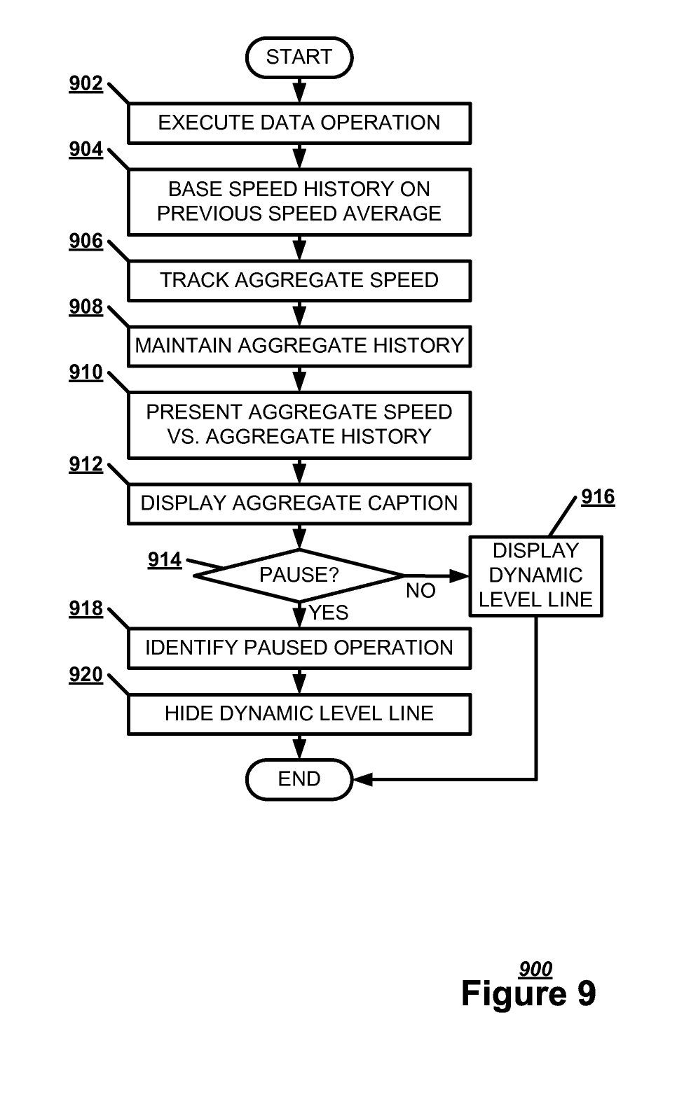

FIG. 9 illustrates, in a flowchart, one embodiment of a method 900 for tracking an aggregate operation speed for concurrent data resource operations. The performance metric tracker may execute a data resource operation (Block 902). The performance metric tracker may base the operation speed history on a previous operation speed average (Block 904). Alternatively, the performance metric tracker may base the operation speed history on an intra-operation performance. The performance metric tracker may track an aggregate current operation speed of a data resource operation (Block 906). The performance metric tracker may maintain an aggregate operation speed history for a data resource operation (Block 908). The performance metric tracker may present the current aggregate operation speed in relation to an aggregate operation speed history to a user (Block 910). The performance metric tracker may describe an aggregate completion percentage by displaying an aggregate completion percentage caption 438 in a dialogue title 436 (Block 912). If the performance metric tracker does not receive a pause instruction from a user for the data resource operation (Block 914), the performance metric tracker may display a dynamic level line 414 in an operation tracking panel 404 in a tracking dialogue box 402 (Block 916). If the performance metric tracker receives a pause instruction for a data resource operation from a user (Block 914), the performance metric tracker may identify a paused operation in a dialogue title 436 (Block 918). The performance metric tracker may hide the dynamic level line 414 in the operation tracking panel 404 for the paused operation upon receiving a pause instruction (Block 920).

Although the subject matter has been described in language specific to structural features and/or methodological acts, it is to be understood that the subject matter in the appended claims is not necessarily limited to the specific features or acts described above. Rather, the specific features and acts described above are disclosed as example forms for implementing the claims.

Embodiments within the scope of the present invention may also include computer-readable storage media for carrying or having computer-executable instructions or data structures stored thereon. Such computer-readable storage media may be any available media that can be accessed by a general purpose or special purpose computer. By way of example, and not limitation, such computer-readable storage media can comprise RAM, ROM, EEPROM, CD-ROM or other optical disk storage, magnetic disk storage or other magnetic data storages, or any other medium which can be used to carry or store desired program code means in the form of computer-executable instructions or data structures. Combinations of the above should also be included within the scope of the computer-readable storage media.

Embodiments may also be practiced in distributed computing environments where tasks are performed by local and remote processing devices that are linked (either by hardwired links, wireless links, or by a combination thereof) through a communications network.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Although the above description may contain specific details, they should not be construed as limiting the claims in any way. Other configurations of the described embodiments are part of the scope of the disclosure. For example, the principles of the disclosure may be applied to each individual user where each user may individually deploy such a system. This enables each user to utilize the benefits of the disclosure even if any one of a large number of possible applications do not use the functionality described herein. Multiple instances of electronic devices each may process the content in various possible ways. Implementations are not necessarily in one system used by all end users. Accordingly, the appended claims and their legal equivalents should only define the invention, rather than any specific examples given.

We claim:

1. A machine-implemented method, comprising:
tracking a current operation performance metric of a data resource operation;
maintaining an operation performance history for the data resource operation;
presenting in realtime the current operation performance metric in relation to the operation performance history to a user.

2. The method of claim 1, further comprising:
basing the operation performance history on an intra-operation performance.

3. The method of claim 1, further comprising:
presenting a granular operation performance history for the data resource operation.

4. The method of claim 3, further comprising:
displaying the granular operation performance history as a line graph.

5. The method of claim 1, further comprising:
presenting the current operation performance metric as a dynamic level line.

6. The method of claim 5, further comprising:
moving the dynamic level line using a smoothing function.

7. The method of claim 1, further comprising:
anticipating a level change in the current operation performance metric.

8. The method of claim 1, further comprising:
describing the current operation performance metric by displaying a metric caption.

9. The method of claim 1, further comprising:
aligning a metric caption position of a metric caption with a dynamic level line representing the current operation performance metric.

10. The method of claim 1, further comprising:
differentiating a line refresh rate for the dynamic level line from a caption refresh rate for a metric caption.

11. The method of claim 1, further comprising:
presenting a source link to connect the user to a data source for a copy operation.

12. The method of claim 1, further comprising:
presenting a target link to connect the user to a data target for a copy operation.

13. A tangible machine-readable medium having a set of instructions detailing a method stored thereon that when executed by one or more processors cause the one or more processors to perform the method, the method comprising:
tracking a current operation speed of a data resource operation;
maintaining an operation speed history for the data resource operation;
presenting in realtime the current operation speed as a dynamic level line in relation to the operation speed history to a user.

14. The tangible machine-readable medium of claim 13, wherein the method further comprises:
basing the operation speed history on a previous operation speed average.

15. The tangible machine-readable medium of claim 13, wherein the method further comprises:
presenting the current aggregate operation speed in relation to an aggregate operation speed history to the user.

16. The tangible machine-readable medium of claim 13, wherein the method further comprises:
describing an aggregate completion percentage by displaying an aggregate completion percentage caption in a dialogue title.

17. The tangible machine-readable medium of claim 13, wherein the method further comprises:
identifying a paused operation in a dialogue title

18. The tangible machine-readable medium of claim 13, wherein the method further comprises:
hiding the dynamic level line for a paused operation upon receiving a pause instruction.

19. A performance metric tracker, comprising:
a memory that maintains an operation performance history for a data resource operation;
a processor that executes an operating system to track a current operation performance metric of the data resource operation; and
a display that presents in realtime a dynamic level line representing the current operation performance metric in relation to a line graph representing the operation performance history to a user.

20. The performance metric tracker of claim 19, wherein the processor moves the dynamic level line using a smoothing function.
